(19) United States
(12) Patent Application Publication
(10) Pub. No.: US 2026/0131490 A1
(43) Pub. Date: May 14, 2026

(54) HAIR CUTTING DEVICE WITH A CUTTING LENGTH ADJUSTMENT DEVICE

(71) Applicant: WAHL GMBH, St. Georgen (DE)

(72) Inventor: Dominik WEISS, Kolbingen (DE)

(21) Appl. No.: 19/371,448

(22) Filed: Oct. 28, 2025

(30) Foreign Application Priority Data
Nov. 13, 2024 (DE) 10 2024 133 192.5

(51) Int. Cl. B26B 19/20

(52) U.S. Cl. CPC B26B 19/205

(57) ABSTRACT

A hair cutting device, including a blade arrangement with a first longitudinally movable cutting element and a second, transversely movable cutting element, a drive device which drives the blade arrangement, and a cutting length adjustment device which cooperates with the first cutting element in such a way that a longitudinal offset can be set between the first cutting element and the second cutting element, wherein the cutting length adjustment device has a lever with a pre-tensioned locking lug for adjusting the second, movable cutting element and at least one holding recess, so that the locking lug engages in the holding recess, wherein the lever further has a sliding sleeve which, in a first position, holds the locking lug against the pre-tensioning force, and in a second position releases the locking lug.

### BACKGROUND

The invention relates to a hair cutting device with a cutting length adjustment device with switching function.

Hair cutting devices with a cutting length adjustment device are known in the prior art. Typically, a hair cutting device has a blade arrangement with two cutting elements, a first of which is longitudinally displaceable for adjusting the cutting length and is firmly connected to the rest of the hair cutting device during the cutting process, and a second of which is arranged so as to be laterally oscillating relative to the first and with which the hair is cut during the cutting process. Cutting elements with comb-like cutting edges are often used, in which case the first cutting element is designed as a so-called shearing comb and comes into contact with the skin of the person or animal to be treated or the user. The second cutting element is then designed as a so-called shearing knife. Each cutting element has a series of spaced apart teeth, wherein the teeth are typically arranged evenly spaced apart from one another. Such a blade arrangement can be designed so that different cutting lengths can be adjusted therewith. The cutting length of such an adjustable blade arrangement is adjusted by longitudinally offsetting the two cutting elements relative to one another, wherein in the case of removable/replaceable blade arrangements the second, transversely movable cutting element is generally offset longitudinally, and in the case of blade arrangements fixedly connected to the hair cutting device the first cutting element is generally offset longitudinally.

Solutions for adjusting the cutting length are known from the prior art, which enable a continuous or stepwise adjustment. Both variants occur approximately equally often, with one or the other variant usually being preferred depending on the user. This means, particularly in hair salons with several hairdressers, that both continuously adjustable hair cutting devices and step-adjustable hair cutting devices are available, although the majority of these two variants are not in use. As a result, the hair salons in question have low machine efficiency, which reduces overall economic efficiency.

Solutions known from the prior art are therefore not very economical, inflexible and often do not offer the optimal adjusting option.

### SUMMARY

The object of the present invention is to provide a hair cutting device with a cutting length adjustment device in which it is easy to switch back and forth between a continuous and a stepped adjustment mode.

A hair cutting device according to the invention comprises a blade arrangement with a first cutting element and a second cutting element which is designed to be movable at least laterally relative to the first cutting element, a drive device which drives the blade arrangement, and a cutting length adjustment device which cooperates with the first cutting element in such a way that a longitudinal offset can be set between the first cutting element and the second cutting element, wherein the cutting length adjustment device has a lever with a pre-tensioned locking lug for adjusting the first, movable cutting element and at least one holding recess such that the locking lug engages in the holding recess so that moving the lever out of the holding recess is made more difficult, in particular prevented, wherein the lever further has a sliding sleeve which holds the locking lug in a first position against the pre-tensioning force and releases the locking lug in a second position. Because the cutting length adjustment device is located outside the hair cutting device and a switching function is provided on the cutting length adjustment device, it is easy to switch between the modes. In addition, no complicated mechanics are required within the hair cutting device, since the mode switching device, which comprises the locking lug and holding recess, is arranged on the cutting length adjustment device outside the hair cutting device.

The sliding sleeve preferably surrounds the lever at least partially. This ensures that the sliding sleeve is held securely on the lever. The sliding sleeve can be closed all the way around, meaning it can completely enclose the lever. However, it is preferred that the sliding sleeve on the side of the locking lug completely covers the lever and engages in a groove on the top and bottom of the lever. This allows the sliding sleeve to interact securely with the locking lug and at the same time ensures that the sleeve can be grasped. If the lever has a rectangular or square cross-section, the sleeve extends in particular over ⅔ of the top and/or bottom of the lever.

The retaining projection is preferably conical and further has a hemispherical end, particularly at the tip. The end may have a flat section. This allows it to slide more easily into the retaining recess and also allows the sliding sleeve to move the locking lug against the pre-tensioning force without any aids.

The sliding sleeve preferably has a recess on the side of the locking lug. In particular, the recess tapers from one input end of the locking lug to the other end, in particular such that the contact points of the recess with the locking lug approach each other from the first position of the sliding sleeve to the second position. This makes it even easier to move the locking lug against the pre-tensioning force.

The recess of the sliding sleeve is preferably circular at one end to provide a seat for the locking lug. This prevents accidental switching between the continuous and stepped adjustment modes, especially when the locking lug has a conical shape. the recess at the input end is wider than the diameter of the locking lug, so that the locking lug does not come into contact with the sliding sleeve in the second position. In the second position, the sliding sleeve can also be spaced apart from the locking lug, so that the sliding sleeve must first be pushed towards the first position in order to come into contact with the locking lug. Preferably, however, the sliding sleeve serves as a stop for the locking lug so that the locking lug is not pushed out of the opening by the spring. This means that the sliding sleeve is at least partially arranged over the opening.

The sliding sleeve preferably projects beyond the surface of the lever on at least one side of the lever or is designed to protrude at least partially. This ensures that the sliding sleeve can be moved more easily, as a user can reach the sliding sleeve safely with his fingers, for example.

The lever is at least partially flat on the side facing the hair cutting device, in particular completely flat. This ensures that the locking lug can engage securely in the retaining recess on the hair cutting device.

Preferably, the sliding sleeve has a projection which is in particular angled, for example by more than 60° or by 90°. This makes it easier to grip and move the sliding sleeve.

### BRIEF DESCRIPTION OF THE DRAWINGS

FIG. 1 shows a hair cutting device with an adjustment lever in a plan view;

FIG. 2 shows an isometric exploded view of a lever of the cutting length adjustment device;

FIG. 3a shows the lever of the cutting length adjustment device in a side view with a sliding sleeve in a first position;

FIG. 3b shows the lever of the cutting length adjustment device in a sectional view with a sliding sleeve in a first position;

FIG. 4a shows the lever of the cutting length adjustment device in a side view with a sliding sleeve in a second position;

FIG. 4b shows the lever of the cutting length adjustment device in a sectional view with a sliding sleeve in a second position.

### DETAILED DESCRIPTION

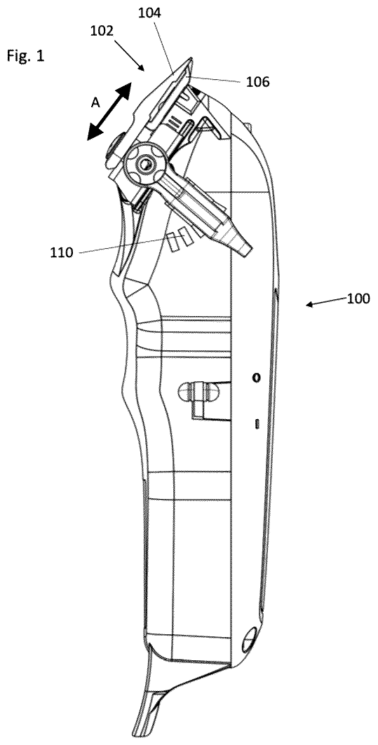

FIG. 1 shows a hair cutting device 100 having a blade arrangement 102 with a first, 104 and a second, transversely movable cutting element 106 which is laterally movable relative to the first cutting element 104. The blade arrangement 102 is driven by a drive device arranged in the housing of the hair cutting device 100. The cutting length adjustment device 10 interacts with the first cutting element 104 or the second cutting element 106 in such a way that a longitudinal offset of the cutting elements 104, 106 can be adjusted between the first cutting element 104 and the second cutting element 106, i.e. when the lever 12 is moved forwards or backwards, the first or second cutting element is moved backwards or forwards (see arrow A) and the cutting length of the hair cutting device 100 is shortened or lengthened. Such a mechanism is known in the prior art. The cutting length is adjusted via a lever 10, which is usually provided on the side of the hair cutting device 100.

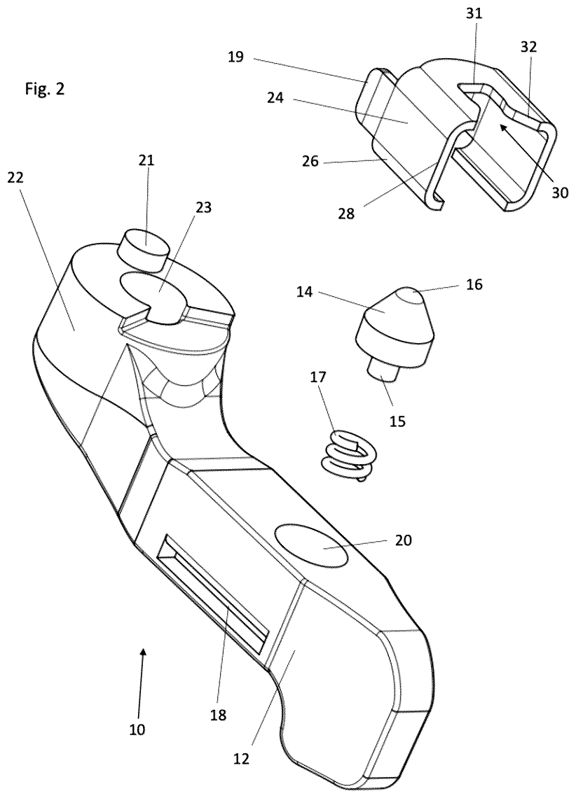

In FIGS. 2 to 4b, the lever of the cutting length adjustment device 10 can be seen in different views. The cross-section of the lever 12 is preferably rectangular or square with rounded edges. In particular, on the side facing the hair cutting device 100, the lever 12 is designed to be as flat as possible. The lever 12 has a locking lug 14 and a sliding sleeve 24. The lever 12 further has a step 13, so that the rotating section 22, around which the lever 12 rotates on the hair cutting device 100, is slightly set back with respect to the lever arm in plan view. The rotating section 22 is then preferably connected via a pin 21 to the adjustment mechanism within the hair cutting device 100, so that rotating the lever 12 moves the first or second cutting element 104, 106 in the longitudinal direction A (FIG. 1). Lateral recesses 110 are provided in the hair cutting device 100, with which the lever 12 interacts, as described later.

In FIG. 2, the lever 10 is shown in an isometric exploded view, with the locking lug 14 arranged on the inner side facing the hair cutting device. Furthermore, the lever 12 also has a sliding sleeve 24 which interacts with the locking lug 14.

The sliding sleeve 24 can be formed completely around the lever, but preferably it only covers the inner side completely, as shown in the figures, and engages on the top and bottom of the lever 12 in an upper groove 18 and a lower groove, which guide the sliding sleeve 24 on the lever 12. The sliding sleeve is preferably U-shaped (as shown here), with inwardly inclined projections at the ends which engage in the grooves 18. One or both of these grooves 18 can serve as a stop for the sliding sleeve 24, so that the movement on the lever 10 is limited. The sliding sleeve 24 protrudes over the surface of the lever, particularly at the top and bottom, so that the sliding sleeve 24 can be moved more easily with the user's fingers. The edges 26 of the sliding sleeve 24 parallel to the lever are preferably rounded on the outside. In particular, the edges 28, which run transversely to the lever, are designed with a clear 90° edge without rounding, so that a user can grip and operate the sleeve more securely. On the inside of the sliding sleeve 24, it rests in particular on the lever 12, for example with a small amount of play. On the inner side, the sliding sleeve 24 has a recess 30, which will be described in more detail below. The sliding sleeve 24 may have a rough texture on the surface so that the grip facilitates the sliding of the sliding sleeve.

The locking lug 14 is pre-tensioned, for example with a spring element, which is shown in the figures as a spiral spring, or with repelling magnetic devices, each of which is arranged below the locking lug 14, so that the locking lug 14 is pressed out of the lever. The locking lug 14 is preferably at least partially conical and arranged in a circular opening 20 in the lever 12. To prevent the locking lug 14 from falling out of the lever 12, the opening 20 can have an undercut below the surface. In the embodiment shown, the sliding sleeve is positioned in the second position with a stop such that the sliding sleeve prevents the locking lug 14 from falling out. At the bottom of the opening 20, a further recess can be arranged which has a smaller diameter than the opening 20 and which serves to support a spring 17. The conical section of the locking lug 14 is preferably the section protruding from the lever 12. The locking lug 14 shown has a circular cross-section, but other basic shapes such as squares, triangles, rectangles or other polygons can also be used. The locking lug tip 16 is preferably provided with a radius and is designed, for example, as a half sphere. More preferably, the tip may be flattened. In particular, the surface at the tip has a flat surface with a radius of 0.5 to 3 mm. On the underside of the locking lug, a guide projection 15 is preferably formed, which is received by the spring 17 and which ensures that the spring 17 and the locking lug 14 are aligned with each other, in particular concentrically. The locking lug 14 is then pressed into the recesses 110 by the spring so that the user receives tactile feedback about the setting of the lever 12.

Preferably, no elements are provided on the outside of the lever handle. The end of the lever 12 can be rounded. A through hole 23 is preferably formed on the rotating section 22, into which a pin of the hair cutting device 100 can be inserted, around which the lever 12 can rotate.

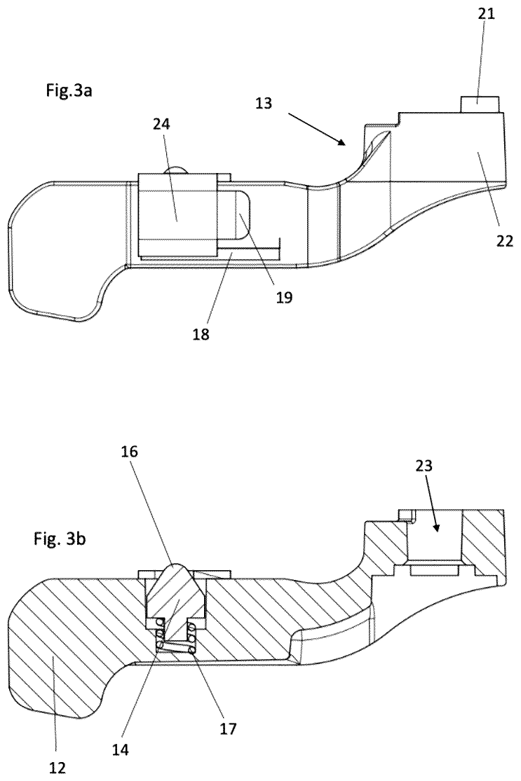

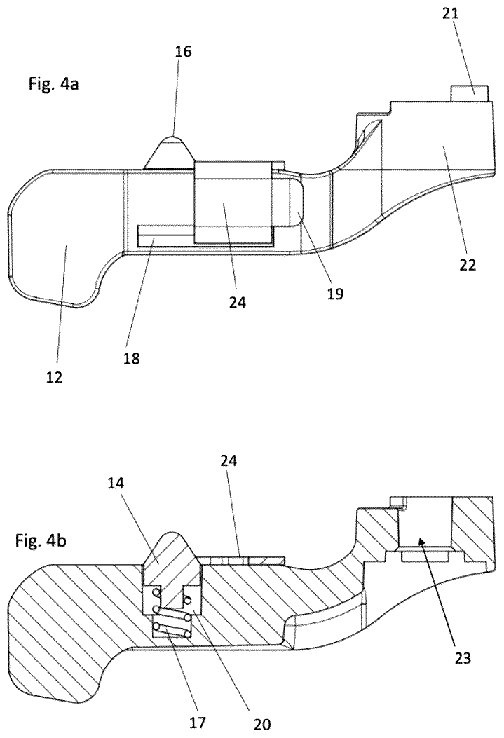

FIGS. 3a and 4a show the lever in a top view. FIGS. 3b and 4b show a longitudinal section of the lever 12 from the same direction. In FIGS. 3a and 3b, the sliding sleeve 24 of the lever is in a first position in which the locking lug 14 is held by the sliding sleeve 24 in a retracted position. This can be done, for example, by the locking lug 14 having a slot into which the sliding sleeve 24 can be inserted and holds the locking lug 14.

It is preferred that the sliding sleeve 24 has a recess 30. This recess 30 is designed in particular such that the locking lug 14 can not only be held in the first retracted position, but is also urged from the second position in which the locking lug 14 protrudes into the first position in which the locking lug 14 is retracted. For this purpose, the recess 30 can, for example, be at least partially tapered, i.e. the edges 32 of the recess approach each other. The holding part in which the locking lug 14 is then held preferably has a rectangular or square shape, so that the end 31 of the recess 30 runs parallel to the edges 28.

At the end of the sliding sleeve 24 directed towards the axis of rotation, a projection 19 is arranged which extends over the sides of the sliding sleeve 24. In particular, this projection 19 extends upwards, preferably at a 90° angle to the surface of the sliding sleeve. The projection 19 is used for better gripping with a finger or thumb.

Alternatively, a circular section can be provided at the end of the recess 30, which has a wider diameter than the distance between the edges 31 at the narrowest point. The locking lug 14 then engages in the circular section 34 and is held there in a retracted position and cannot independently slide back into the tapered section. The circular section 34 is therefore a seat for the locking lug 14. The inlet side of the recess 30 is preferably larger than the largest diameter of the locking lug 14, which protrudes from the lever. In the second position of the sliding sleeve

FIGS. 4a and 4b show the sliding sleeve 24 of the lever in a second position in which the sliding sleeve 24 releases the locking lug 14. In FIG. 4b it can be seen that the sliding sleeve 24 is not arranged completely away from the locking lug 14, but that the sliding sleeve 24 protrudes beyond the edge of the opening 20 and thus serves as a stop for the locking lug 14.

When the sliding sleeve 24 is then pushed from the second to the first position, the recess edges 32 contact the side surfaces of the conically shaped locking lug 14. Due to the tapered design, the locking lug 14 is then pressed downwards the closer the contact points approach the recess 30.

In the first position of the sliding sleeve 24, the lever 12 is continuously adjustable. In this case, the locking lug 14 is retracted by the sliding sleeve 24 and the tip 16 of the locking lug 14 is lifted from the hair cutting device 100, so that the locking lug 14 cannot engage in the recess 110 for the locking lug 14. In the second position of the sliding sleeve 24, the locking lug 14 protrudes further from the lever 12 due to the spring force of the spring 17 and the missing stop of the sliding sleeve 24, so that the tip 16 of the locking lug 14 contacts the hair cutting device 100 and the tip 16 engages in the recess 110 for the locking lug 14. This allows the user to feel exactly when the locking lug 14 engages or slides out of the recess 110.

While a particular embodiment of the present hair cutting device with a cutting length adjustment device has been described herein, it will be appreciated by those skilled in the art that changes and modifications may be made thereto without departing from the invention in its broader aspects and as set forth in the following claims.

### List of Reference Numerals

10 cutting length adjustment device
12 lever
13 step
14 locking lug
15 guide projection
16 locking lug tip
17 spring
18 upper groove
19 projection
20 opening
21 pin
22 rotating section
23 through hole
24 sliding sleeve
28 edges
30 recess
31 end of the recess
32 recess edges
34 circular recess
100 hair cutting device
102 blade arrangement
104 first cutting element
106 second cutting element
110 recesses for locking lug

1. A hair cutting device, comprising:
a blade arrangement having a first cutting element and a second cutting element which is designed to be movable at least laterally relative to the first cutting element;
a drive device that drives the blade arrangement; and
a cutting length adjustment device which cooperates with the first cutting element or second cutting element in such a way that a longitudinal offset can be set between the first cutting element and the second cutting element; wherein the cutting length adjustment device has a lever with a pre-tensioned locking lug for adjusting the first or second cutting element and at least one holding recess, so that the locking lug engages in the holding recess;
the lever further comprises a sliding sleeve which, in a first position, holds the locking lug against the pre-tensioning force and, in a second position, releases the locking lug.

2. The hair cutting device according to claim 1, wherein the sliding sleeve at least partially surrounds the lever.

3. The hair cutting device according to claim 1, wherein the sliding sleeve on the top and bottom of the lever engages in a groove of the lever.

4. The hair cutting device according to claim 1, wherein the locking lug is at least partially conical.

5. The hair cutting device according to claim 1, wherein the sliding sleeve has a recess on the side of the locking lug.

6. The hair cutting device according to claim 5, wherein the recess tapers from one input end to the other end.

7. The hair cutting device according to claim 5, wherein the recess at one end is circular to provide a seat for the locking lug.

8. The hair cutting device according to claim 5, wherein the recess at the input end is larger than the diameter of the locking lug protruding from the lever.

9. The hair cutting device according to claim 5, wherein the sliding sleeve serves as a stop for the locking lug in the second position, so that the locking lug is held by the sliding sleeve in the opening.

10. The hair cutting device according to claim 1, wherein the sliding sleeve projects beyond the surface of the lever on at least one side of the lever.

11. The hair cutting device according to claim 1, wherein the lever is at least partially flat on the side facing the hair cutting device.
